(19) United States
(12) Patent Application Publication
(10) Pub. No.: US 2025/0239649 A1
(43) Pub. Date: Jul. 24, 2025

(54) FREE-STANDING SULFIDE SOLID ELECTROLYTE SEPARATORS

(71) Applicant: UT-Battelle, LLC, Oak Ridge, TN (US)

(72) Inventors: Guang Yang, Knoxville, TN (US); Xi Chen, Knoxville, TN (US); Daniel Hallinan, Oak Ridge, TN (US); Jagjit Nanda, Oak Ridge, TN (US); Anna Mills, Oak Ridge, TN (US)

(21) Appl. No.: 19/029,219

(22) Filed: Jan. 17, 2025

Related U.S. Application Data
(60) Provisional application No. 63/622,930, filed on Jan. 19, 2024.

(51) Int. Cl. H01M 10/0562; H01M 10/0525; H01M 50/403; H01M 50/417; H01M 50/431; H01M 50/446

(52) U.S. Cl. CPC H01M 10/0562; H01M 10/0525; H01M 50/403; H01M 50/417; H01M 50/431; H01M 50/446; H01M 2300/0068; H01M 2300/008

(57) ABSTRACT

A method of manufacturing a free-standing, sheet-type solid-state electrolyte is provided. The method includes: mixing a sulfide ion conductor-containing material and a non-polar or low-polar binder in a solvent to obtain a slurry composition; disposing the slurry composition onto a planar substrate; spreading the slurry composition on the substrate to obtain a film; calendering the film to densify the film; and subsequently drying the film under vacuum. The binder may be polyisobutylene and may be present in the slurry composition in an amount of up to 10 wt. %, optionally between 1 and 5 wt. %. The sulfide ion conductor-containing material may be a lithium argyrodite having the chemical formula Li₆PS₅X in which X is Cl, Br, or I. The solvent may be toluene or xylene. The film may have a thickness of between 10 and 200 μm.

### CROSS-REFERENCE TO RELATED APPLICATIONS

This application claims the benefit of U.S. Provisional Application No. 63/622,930, filed Jan. 19, 2024, the disclosure of which is incorporated by reference in its entirety.

### STATEMENT REGARDING FEDERALLY SPONSORED RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a method of manufacturing free-standing, sheet-type solid-state electrolytes for battery electrodes, and free-standing, sheet-type solid-state electrolytes obtained by the method.

### BACKGROUND OF THE INVENTION

Advances in solid electrolytes (SEs) with superionic conductivity and stabilized electrode-electrolyte interfaces are key enablers for all solid-state batteries (SSBs) to meet the energy density and cost targets for next-generation batteries for electric vehicles and other applications such as portable electronic devices. There are two broad classes of solid electrolytes: inorganic oxide or sulfide-based electrolytes and polymer-based electrolytes. Inorganic electrolytes offer excellent ionic conductivities (e.g., in a range of from 10⁻⁴ to 10⁻¹ S/cm). In comparison to oxide-based SEs, sulfide-based SEs offer better ionic conductivity and processability. Also, sulfur is an inexpensive, earth-abundant element, making sulfides an attractive option for next-generation SEs. However, to meet the energy storage requirements demanded by the blossoming electric vehicle market, the development of processing techniques amenable to existing industrial processes is paramount. Sheet-type, free-standing SE films are therefore of great interest since they can be readily integrated into the current roll-to-roll infrastructure in Li-ion battery manufacturing lines. Most lab-based research efforts focus on pelletizing sulfide SEs. Pressing pellets is disadvantageous for two primary reasons: 1) the pressures required to form a pellet approach prohibitive levels when scaled up from laboratory-size (˜1″ in diameter); and 2) due to their poor mechanical properties, pellets have a finite lower bound on their thickness which limits their cell-based energy densities. Alternatively, sulfide SE membranes may be formed by grinding sulfide material into a fine powder, mixing with a thermoplastic polymer binder, and pressing into a sheet. However, this technique exhibits difficulty in controlling the resulting microstructure, has poor scalability, and leads to inhomogeneous distribution of binder and sulfide particles. Therefore, a continued need exists for improved processes of forming sulfide-based, free-standing, sheet-type solid-state electrolytes.

### SUMMARY OF THE INVENTION

A method of manufacturing a free-standing, sheet-type solid-state electrolyte is provided. The method includes mixing a sulfide ion conductor-containing material and a binder in a solvent to obtain a slurry composition. The binder is a generally non-polar or low-polar binder. The method further includes disposing the slurry composition onto a planar substrate. The method further includes spreading the slurry composition on the substrate with one of a drawdown bar or a slot die to obtain a film. The method further includes calendering the film to densify the film, and subsequently drying the film under vacuum. The method allows for the formation of a flexible, free-standing, sheet-type electrolyte that has a minimal thickness, excellent mechanical strength, excellent ionic conductivity, and is suitable as a separator in a battery cell.

In specific embodiments, the method further includes the step of cold-pressing the film after calendering.

In specific embodiments, the substrate is a silicone-coated mylar.

In specific embodiments, the substrate is an electrode material.

In specific embodiments, the binder is an elastomer.

In particular embodiments, the binder is selected from a group consisting of: polyisobutylene (PIB), styrene butadiene rubber (SBR), nitrile butadiene rubber (NBR), hydrogenated nitrile butadiene rubber (HNBR), ethylene-propylene-diene monomer (EPDM), and styrene-butadiene-styrene (SBS).

In certain embodiments, the binder is polyisobutylene (PIB).

In specific embodiments, the binder is present in the slurry composition in an amount of up to 10 wt. %

In particular embodiments, the binder is present in the slurry composition in an amount of between 1 and 5 wt. %.

In specific embodiments, the sulfide ion conductor-containing material is a lithium argyrodite having the chemical formula Li₆PS₅X wherein X is one of Cl, Br, or I.

In particular embodiments, the sulfide ion conductor-containing material is Li₆PS₅Cl (LPSCl).

In specific embodiments, the sulfide ion conductor-containing material is one of Li₁₀GeP₂S₁₂ (LGPS) or Li₁₀SnP₂S₁₂ (LSPS).

In specific embodiments, the solvent is one of toluene or xylene.

In specific embodiments, the film has a thickness of between 10 and 200 μm.

A free-standing, sheet-type solid-state electrolyte manufactured by the method is also provided.

In specific embodiments, the free-standing, sheet-type solid-state electrolyte includes sulfide particles bound by the binder, and the binder is a polymer binder.

In specific embodiments, the free-standing, sheet-type solid-state electrolyte has a thickness of between 10 and 200 μm.

These and other features of the invention will be more fully understood and appreciated by reference to the description of the embodiments and the drawings.

### BRIEF DESCRIPTION OF THE DRAWINGS

FIG. 1 is a schematic illustration of a method of manufacturing a free-standing, sheet-type sulfide solid-state electrolyte in accordance with embodiments of the disclosure;

FIG. 2 is a graph of Nyquist plots showing decreased interfacial resistance after cold pressing of a C@ Al|5 wt. % PIB-LPSCl|C@Al cell;

FIG. 3 is a pictorial view of SEM images of surface planes and cross-sections of 0-5 wt. % PIB-LPSCl composites in accordance with embodiments of the disclosure;

FIG. 4 is a pictorial view of SEM images further processed in MATLAB (upper row) and ImageJ (lower row) of 0-5 wt. % PIB-LPSCl composites in accordance with embodiments of the disclosure, illustrating apparent porosity of the composites;

FIG. 5 is a graph of apparent porosity and bulk (calculated) porosity of 0-5 wt. % PIB-LPSCl composites in accordance with embodiments of the disclosure;

FIG. 6 is a graph of Nyquist plots at 30 MPa stack pressure, and approximately two minutes after removal of the 30 MPa stack pressure, of 0-5 wt. % PIB-LPSCl composites in accordance with embodiments of the disclosure;

FIG. 7 is a graph of conductivity as a function of stack pressure (0.05-20 MPa) of 0-5 wt. % PIB-LPSCl composites in accordance with embodiments of the disclosure;

FIG. 8 is a graph of raw data and Arrhenius fits of temperature-dependent ionic conductivity of 0-5 wt. % PIB-LPSCl composites in accordance with embodiments of the disclosure;

FIG. 9 is a graph of conductivity as a function of temperature (20-80° C.) of 0-5 wt. % PIB-LPSCl composites in accordance with embodiments of the disclosure;

FIG. 10 is a graph of the first ten charge/discharge cycles for a 125 mg neat LPSCl electrolyte pellet and a 5 wt. % PIB-LPSCl composite electrolyte in accordance with embodiments of the disclosure;

FIG. 11 is a graph of charge/discharge cycles for a critical current density test of a 125 mg neat LPSCl electrolyte pellet and a 5 wt. % PIB-LPSCl composite electrolyte in accordance with embodiments of the disclosure; and

FIG. 12 is a graph of Nyquist plots before and after cell failure of a 125 mg neat LPSCl electrolyte pellet and a 5 wt. % PIB-LPSCl composite electrolyte in accordance with embodiments of the disclosure.

### DETAILED DESCRIPTION OF THE CURRENT EMBODIMENTS

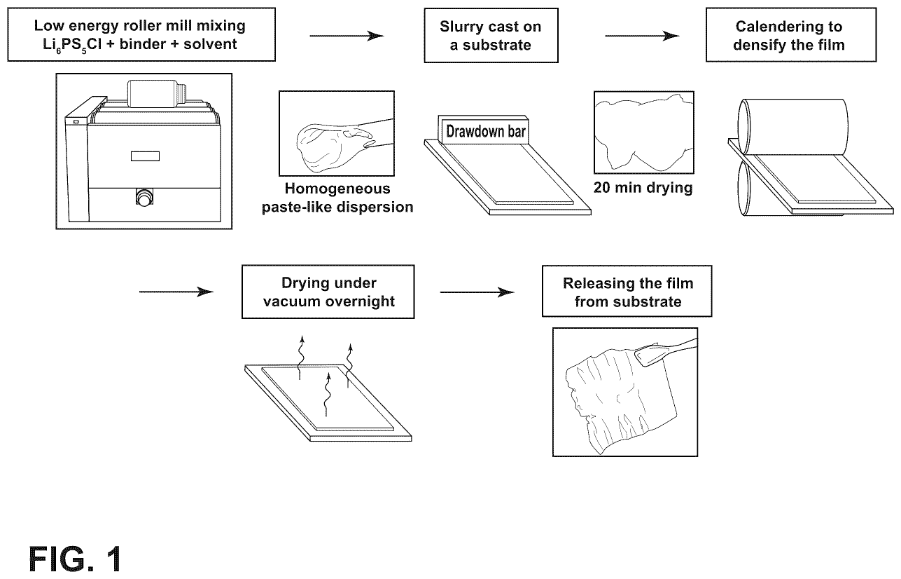

As discussed herein, the current embodiments relate to a method of manufacturing a free-standing, sheet-type solid-state electrolyte. As generally illustrated by way of example in FIG. 1, the method includes mixing a sulfide ion conductor-containing material and a binder in a solvent to obtain a slurry composition, disposing the slurry composition onto a planar substrate, spreading the slurry composition on the substrate, calendering the film to densify the film, and drying the film under vacuum. Each step is separately discussed below.

The method first includes mixing a sulfide ion conductor-containing material and a binder in a solvent to obtain a slurry composition. For example, the binder may be dissolved in the solvent, and subsequently the sulfide ion conductor-containing material may be added to the solution. The resulting set of components is then mixed by any suitable mixing technique, such as for example ball milling, to form the slurry composition. The mixing may be performed at or near room temperature.

In various embodiments, the solvent is either toluene, xylene, or a mixture thereof. In exemplary embodiments, the solvent is particularly toluene. In some embodiments, the solvent is a non-polar organic solvent. Also, in some embodiments, the solvent or mixture of solvents has a dielectric constant less than 2.5 at 25° C. In other embodiments, the solvent may be an aryl solvent or mixture of aryl solvents.

The sulfide ion conductor-containing material includes sulfur(S) in its composition, and in the case that the electrolyte obtained by the method is intended for use in a lithium-ion battery, the sulfide ion conductor-containing material also may include lithium (Li). In various embodiments, the sulfide ion conductor-containing material is either a lithium argyrodite (Li₆PS₅X; X=Cl, Br, or I), Li₁₀GeP₂S₁₂ (LGPS), or Li₁₀SnP₂S₁₂ (LSPS). In exemplary embodiments, the sulfide ion conductor-containing material is particularly Li₆PS₅Cl (LPSCl). The sulfide ion conductor-containing material may be prepared from precursor materials as part of the method or may be obtained pre-made for direct use in the method.

The binder is a generally non-polar or low-polar material. By generally non-polar, it is meant that the material has no polarity (charge separation) or a nominal polarity, and by low-polar, it is meant that the material has a small degree of polarity but significantly less polarity than a polar material. In some embodiments, the low-polar material has a dielectric constant less than 2.5 at 25° C. In various embodiments, the binder is a rubber-like, elastomeric polymer. For example, the binder may be polyisobutylene (PIB), styrene butadiene rubber (SBR), nitrile butadiene rubber (NBR), hydrogenated nitrile butadiene rubber (HNBR), ethylene-propylene-diene monomer (EPDM), styrene-butadiene-styrene (SBS), another similar elastomer, or a combination thereof. In exemplary embodiments, the binder is particularly polyisobutylene (PIB). The binder may be present in the slurry composition in an amount of up to approximately 10 wt. %, based on the weight of the binder and sulfide ion conductor-containing material (dry with no solvent, or in other words, based on the amount of binder that is present in the dry membrane that is formed), optionally up to approximately 9 wt. %, optionally up to approximately 9 wt. %, optionally up to approximately 8 wt. %, optionally up to approximately 7 wt. % optionally up to approximately 6 wt. %, optionally up to approximately 5 wt. %. In exemplary embodiments, the binder loading in the slurry composition may be in a range of between approximately 0.5 wt. % and 5.0 wt. %, optionally between 1.0 wt. % and 5.0 wt. %, optionally between 1.5 wt. % and 5.0 wt. %, optionally between 2.0 wt. % and 5.0 wt. %, optionally between 2.5 wt. % and 5.0 wt. %, optionally between 3.0 wt. % and 5.0 wt. %, optionally between 3.5 wt. % and 5.0 wt. %, optionally between 4.0 wt. % and 5.0 wt. %, optionally between 0.5 wt. % and 4.5 wt. %, optionally between 0.5 wt. % and 4.0 wt. %, optionally between 0.5 wt. % and 3.5 wt. %, optionally between 0.5 wt. % and 3.0 wt. %, optionally between 0.5 wt. % and 2.5 wt. %, optionally between 0.5 wt. % and 2.0 wt. %, optionally between 0.5 wt. % and 1.5 wt. %, optionally between 1.0 wt. % and 4.5 wt. %, optionally between 1.0 wt. % and 4.0 wt. %, optionally between 1.0 wt. % and 3.5 wt. %, optionally between 1.0 wt. % and 3.0 wt. %, optionally between 1.0 wt. % and 2.5 wt. %, optionally between 1.0 wt. % and 2.0 wt. %.

The method then includes disposing the slurry composition onto a planar substrate and spreading the slurry composition on the substrate to cast the slurry. The manner of disposing the slurry composition onto the substrate is not particularly limited and may be performed by any suitable manner such as, for example, pouring or otherwise feeding the slurry composition onto the surface of the substrate. The spreading of the slurry composition on the substrate may be performed, for example, using a drawdown bar that is moved along the surface of the substrate on which the slurry composition is disposed. Alternatively, the slurry composition may be simultaneously disposed and spread on the substrate, such as by delivering the slurry composition onto the substrate with a slot-die. The substrate is not particularly limited, but in exemplary embodiments the substrate may be a silicone-coated mylar or other similar material from which the cast slurry composition later may be easily released. Alternatively, the substrate may be a battery electrode material onto which the slurry composition is permanently fixed for inclusion in a battery cell.

The method next includes calendering the cast film to densify the film. Prior to calendering, the cast film may be allowed to dry naturally for a period of time of, for example, at least 15 minutes, optionally at least 20 minutes, optionally at least 30 minutes, optionally at least 1 hour. The calendering may be performed by any suitable means, such as for example, using a cold roller press or similar. In order to perform the calendering, another layer of substrate material may be placed on top of the cast film to sandwich the cast film between two layers of substrate material. The calendering may reduce the thickness of the film. After calendering, the film may be cold pressed to further reduce the thickness of the film. Subsequent to densification, the resulting film may be dried under a vacuum for a period of at least 12 hours, optionally at least 18 hours, optionally at least 24 hours, optionally at least 30 hours, optionally at least 36 hours, optionally at least 42 hours, optionally at least 48 hours. Subsequent to calendering and/or drying, the obtained film may be released from the substrate. The obtained film may have a thickness in a range of approximately 10 to 200 μm, optionally between 10 and 175 μm, optionally between 10 and 150 μm, optionally between 10 and 125 μm, optionally between 10 and 100 μm, optionally between 10 and 75 μm, optionally between 10 and 50 μm, optionally between 20 and 50 μm.

The above method is well-suited for manufacturing a free-standing, sheet-type solid-state electrolyte that includes sulfide particles bound by a polymer binder. The obtained electrolyte is particularly useful as an electrolyte material for an all solid-state battery. The obtained electrolyte has a minimal thickness of less than 200 μm, alternatively less than 50 μm. In certain embodiments, the sulfide particles are formed of LPSCl, the polymer binder is PIB, and the solvent used in preparing the slurry composition is toluene. The compatibility between the solvent, binder, and sulfide particles is critical for the fabrication of the free-standing, sheet-type solid-state electrolyte and plays a decisive role in their stability, structural integrity, and performance in solid-state batteries.

### EXAMPLES

The present method is further described in connection with the following laboratory examples, which are intended to be non-limiting.

Poly(isobutylene) (PIB) (850 kg/mol) obtained from Scientific Polymer Products, Inc. of New York was dried at 100° C. under vacuum overnight and dissolved in anhydrous toluene that was dried using 4 Å molecular sieves for a minimum of two weeks. Li₆PS₅Cl (LPSCl) (3-5 μm) obtained from NEI Corp. of New Jersey was used as the lithium argyrodite compound.

As shown by way of example in FIG. 1, in one exemplary embodiment for preparing the free-standing sulfide-containing flexible electrolyte film, PIB was dissolved in toluene and subsequently LPSCl was added to the solution to make 0, 1, 2, or 5 wt. % PIB-content mixtures with a solid electrolyte (SE) mass ratio (dry SE:polymer solution) of 0.6. The slurries were mixed via ball milling with, for example, 5 mm ZrO₂ balls for a minimum of 18 hours. Subsequently, the slurries were tape cast in an argon atmosphere onto a silicone-coated mylar substrate, obtained from The Tape Casting Warehouse, using a drawdown bar set to, for example, a 0.008 inch gap. The resulting films were dried for a time period of, for example, 20 minutes. After drying, the top sides of the films were covered with an identical silicone-coated mylar substrate, and the entire sandwich assembly was sealed in a pouch for calendering at room temperature using a cold roller press (MSK-HRP-MR100DC) from MTI Corp. of California. The films were then removed from the pouch in an Ar-filled glovebox and dried under vacuum for two days.

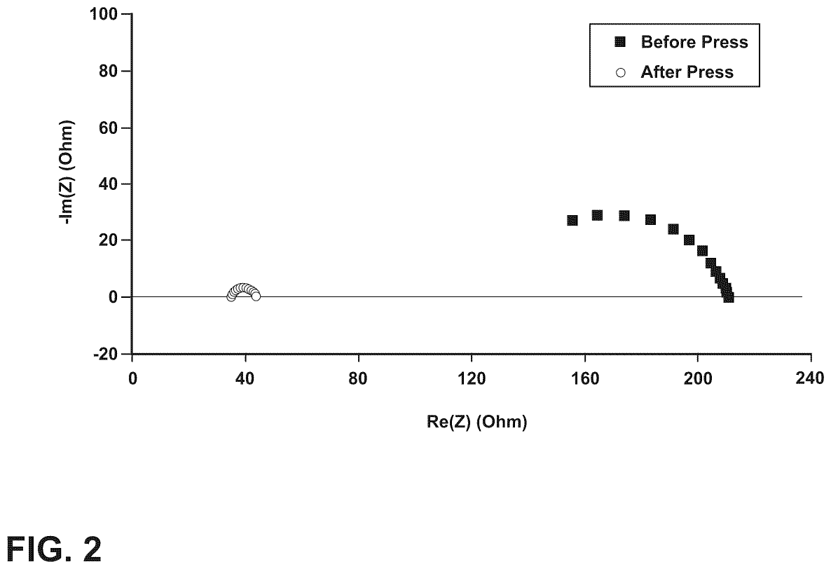

All temperature-dependent ionic conductivity measurements were performed in CR2032-type coin cells. Film samples were weighed and cold pressed with carbon-coated aluminum (C@Al) current collectors in a ½″ stainless steel split die at 600 MPa for 5 minutes. Formed C@Al|LPSCl|C@Al symmetric cells were ejected from the die and hermetically sealed in a coin cell with a spring and 500-μm-thick stainless steel spacer. The symmetric cells were cold pressed to form good contact with the electrode surface. The Nyquist plots in FIG. 2 show the effects of the pressing step on the interfacial resistance.

The temperature-dependent conductivity measurements were performed on the toluene-treated LPSCl (having 0 wt. % PIB) and PIB-LPSCl composite samples (having 1, 2, or 5 wt. % PIB) prepared as described above. The coin cells were secured in coin-cell holders and placed in a programmable climate control chamber. Potentiostatic electrochemical impedance spectroscopy (PEIS) was conducted at temperatures between 8° and 20° C. in 10° C. increments for 4 cycles using a VMP3 potentiostat from Biologic. The samples were held at each temperature for 1⅓ hours to ensure thermal equilibrium before each measurement.

All pressure-dependent ionic conductivity and Li stripping/plating data was collected using poly(ether ether ketone) (PEEK) cells. PEEK cell assemblies were fabricated in-house and consisted of a ½″ PEEK mold fixed to a steel baseplate, a stainless-steel spacer, electrodes on either side of the film sample, another stainless-steel spacer, and a stainless-steel plunger.

The pressure-dependent ionic conductivity measurements were taken in the PEEK cells at room temperature. Approximately 50 mg samples of the toluene-treated LPSCl (denoted hereinafter as 0 wt. %) and PIB-LPSCl were measured into respective PEEK cells with two ½″ C@Al current collectors. The 0, 1, 2, and 5 wt. % PIB-LPSCl samples were pressed at 20 MPa for 5 minutes. At the end of 5 minutes, conductivity was recorded, and the pressure was released. After an additional 5 minutes, a 10 MPa stack pressure was applied, and conductivity was again recorded. This process was repeated with a stack pressure of 5 MPa. Finally, the conductivity was recorded at approximately 0.5 MPa. The approximate time between measurements was 10 minutes. Final pellet thicknesses ranged from 323 to 364 μm post-fabrication.

Li stripping and plating tests were performed in the PEEK cells at room temperature. The cells were cold pressed at 600 MPa for 5 minutes with Li-coated copper electrodes (Li@Cu; 40 μm Li layer) obtained from MSE Supplies LLC and cycled with a stack pressure of ˜1 MPa. Cells were cycled at +40 μA/cm² for 100 charge/discharge cycles, with 1 hour for striping followed by 1-hour plating. To assess critical current density, the Li|LPSCl|Li symmetric cells were respectively cycled for 6 charge/discharge cycles at 80 μA/cm², 118 μA/cm², and 236 μA/cm².

Morphology of the samples was evaluated using scanning electron microscopy (SEM) (Zeiss MERLIN Field Emission SEM) equipped with an In-lens detector. An accelerating voltage of 1 kV was used. ImageJ and MATLAB's Image Processing Toolbox were used to process micrographs. Collected tiff files were first cropped and converted to grayscale images. Using a reference image and MATLAB's imhisteq function, grayscale images underwent histogram matching to equalize brightness and contrast. Images were then converted back to tiff files for further processing. In ImageJ, image type was converted to 8-bit, and pixel value thresholding was performed to isolate visible pores or dips on the sample surface as white spots on a black background. Apparent surface porosity values were taken as the percentage of white pixels. For each sample, results from four images at different magnifications were processed: 500×, 1k×, 5k×, and 10k×.

All Raman maps were collected on a confocal Raman spectrometer (532 nm, objective=20×, a grating with 600 grooves/mm, numerical aperture (N.A.)=0.42, local power <500 μW) from WITec, GmbH. The laser spot diameter was estimated to be 1 μm. The scan region was set to 50×50 μm², with a step size of 1 μm²/pixel. The integration time was set to 3 seconds for each point. All Raman mappings were analyzed using Witec ProjectPlus software and the K-means clustering algorithm integrated into the Scikit-learn platform.

K-means clustering analysis was performed to distill the information out of the 2,500 spectra in each mapping frame (50×50 μm²). The structural heterogeneity of the samples can be unveiled by the K-means clustering analysis on the Raman mapping of the object. The method of analysis includes grouping the total number (denoted as n) of Raman spectra (x₁, x₂, x₃ . . . xₙ) within the Raman mapping into K sets (K≤n), to minimize the sum of squares within-cluster, defined by the objective function, J as

$$J = arg min {\sum }_{i = 1}^{k} {\sum }_{x ∈ {S}_{i}} {‖ x - {c}_{i} ‖}^{2}$$

in which cᵢ is the mean of points (or centroid). It serves as the cluster spectrum in the K set, Sᵢ. The value of the centroid is updated iteratively, based on

$${c}_{i}^{new} = \frac{1}{\vert {S}_{i} \vert} {\sum }_{{x}_{j} ∈ {S}_{i}} {x}_{j}$$

Consequently, the total number of n spectra can be categorized into several clusters with similarities, with each cluster color coded in the label map.

The results of the evaluation of the samples demonstrated that the addition of PIB allowed for the formation of flexible, thin, free-standing, sheet-type sulfide SE separators. With respect to the dimensional integrity of the obtained sulfide SE separators, without any binder (0 wt. % PIB) the sample material would not form a single integral sheet. The LPSCl powder formed brittle and plate-like chunks when slurry processed with toluene and tape cast. On the other hand, robust free-standing sheets were achieved with a minimum of 2 wt. % PIB.

The as-cast PIB-LPSCl sheet thickness ranged from 120 to 250 μm. Film quality visually appeared to increase with increasing binder content. Upon calendering, the thickness was reduced by 45±8% for 2 wt. % PIB-LPSCl and 52±11% for 5 wt. % PIB-LPSCl. The thickness of 1 wt. % PIB-LPSCl did not decrease significantly upon calendering (12±12%). Samples that were cold pressed after calendering realized additional thickness decreases of 13±8%, 25±16%, and 21±17% for 1, 2, and 5 wt. % PIB-LPSCl, respectively.

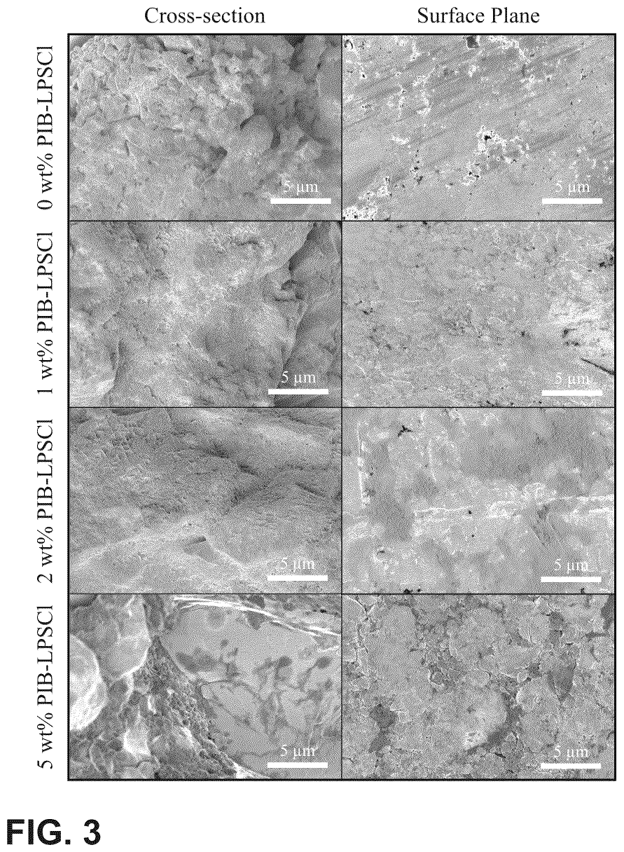

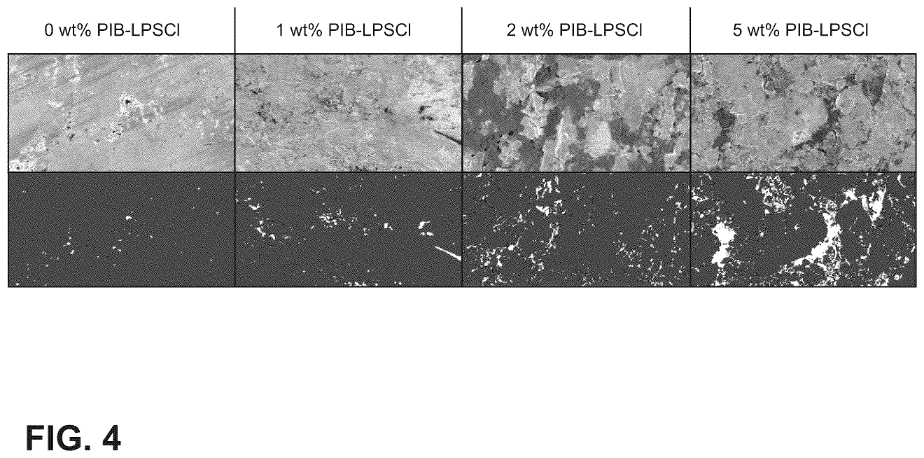

Morphological changes that occurred as a result of binder loading can be observed in SEM images of the cross-sections and surface planes of calendered, pressed pellets. Representative SEM images of 0, 1, 2, and 5 wt. % PIB-LPSCl samples are shown in FIG. 3. From the cross-sectional views, particle boundaries are seen to become more pronounced at 5 wt. % binder loading, revealing a population of small (≲1 μm) particles and one large (>15 μm) particle aggregate structure. At lower binder loadings, particle size homogeneity is not as easily assessed due to interparticle caking. From the planar views, surface porosity appears to increase with increasing binder content. Using image processing techniques, the apparent porosity (expressed as a percent of image area) was estimated. Examples of the processed images are shown in FIG. 4.

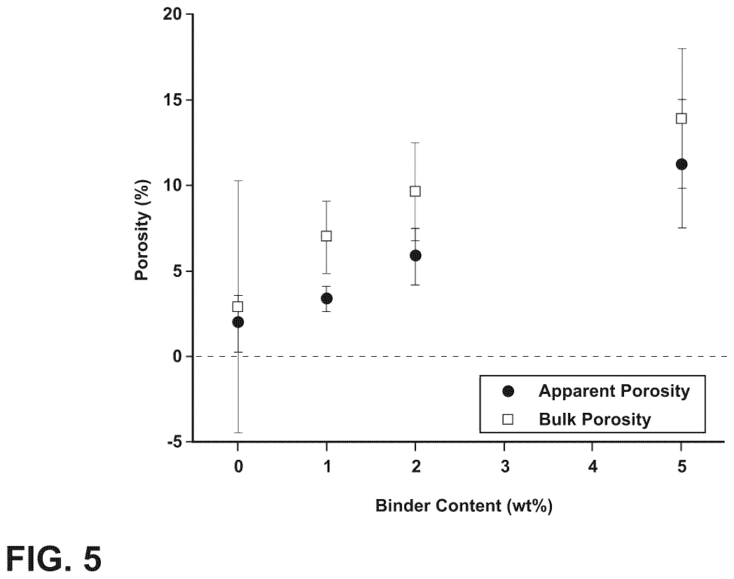

To validate these results, bulk porosity was also tabulated. The porosity (q) of the LPSCl samples was calculated based on the following equations,

$${ρ}_{c , theoretical} = {[ ( \frac{{w}_{PIB}}{{ρ}_{PIB}} ) + ( \frac{{w}_{LPSCl}}{{ρ}_{LPSCl}} ) ]}^{- 1}$$

$${ρ}_{c , experimental} = \frac{{m}_{c}}{π {r}^{2} h}$$

$$φ = ( \frac{{ρ}_{c , theoretical} - {ρ}_{c , experimental}}{{ρ}_{c , theoretical}} ) \times 100 \%$$

where W_{PIB} is the weight fraction of PIB, W_{LPSCl} is the weight fraction of LPSCl, ρ_{PIB} is the mass density of PIB (0.92 g/cm³), ρ_{LPSCl} is the mass density of LPSCl (1.64 g/cm³), and ρ_{c,theoretical} is the theoretical mass density of the composite. The experimental composite mass density, ρ_{c,experimental}, was calculated using the mass of the PIB-LPSCl composite, mc, the radius of the die, r=0.635 cm, and thickness of the composite, h. The bulk porosity and apparent porosity values are plotted in FIG. 5. As shown, the bulk porosity is 34% greater than the apparent porosity, which in combination with SEM observations, suggests the internal porosity of the composites is more prominent than their surface porosity. Stated conversely, the porosity on the surface of the composites is less prominent than their internal porosity.

The surface structure and chemistry of the free-standing LPSCl thin sheets were characterized using Raman mapping and unsupervised learning methods. The Raman mapping based on single peak intensity revealed that both the 0 wt. % PIB-LPSCl and 5 wt. % PIB-LPSCl samples had LPSCl deficient locations. However, while Raman mapping based on single peak intensity can show the chemical distribution of a given species, it fails to reflect the relative distribution of multiple components and may miss important spectral features of the object. Therefore, K-means clustering analysis was used to distill information from the 2500 spectra in each mapping frame (50×50 μm²). The 2500 spectra of each Raman mapping were clustered into five groups for each sample, with each cluster representing a characteristic structure or chemistry and coded by a specific color, resulting in similarity loading maps. The centroid spectrum of each cluster represented the characteristic features of all spectra in that category. The centroid spectra of the 0 wt. % PIB-LPSCl exhibited featured Raman bands for the LPSCl, with a distinguished peak centered at 429 cm⁻¹, overlapping with that of the pristine LPSCl powder. This indicated that LPSCl proceeded by toluene retains its structure. The P-S stretch mode was centered at 429 cm⁻¹ for all clusters of the 5 wt. % PIB-LPSCl samples, suggesting that PIB binder addition did not disrupt the LPSCl structure. However, clusters orange and brown exhibited a peak at 1071 cm⁻¹, likely attributed to the C-C stretch mode of the PIB polymer binder. The size of these two clusters was on the scale of 10 μm, consistent with the structural defect observed from the SEM micrograph shown in FIG. 2. Thus, the K-means clustering analysis of the Raman mapping demonstrated that the solution processing of the PIB binder with toluene did not change the LPSCl structure. However, the addition of the PIB binder led to local phase segregation due to immiscibility between the binder and LPSCl.

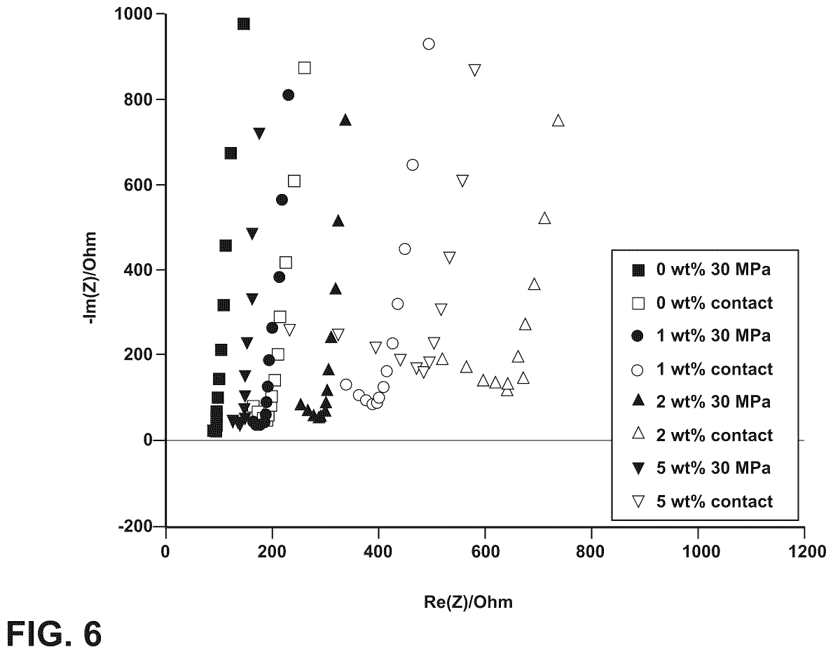

The relaxation of the polymer binder may affect percolation of ion-transport pathways through the free-standing LPSCl thin sheet under different compressive stress values. While the pressure dependent ion transport properties have been well explored for cold pressed sulfide SEs, study of free-standing sulfide SE separators is lacking. The pressure dependent ionic transport property can be gleaned from the impedance spectroscopy at various stack pressure values. The EIS was taken at a stack pressure of 30 MPa and again after decreasing the stack pressure to about 0.5 MPa. Upon decreasing the stack pressure, the absolute resistance increased. This was to be expected since increased stack pressures are known to decrease resistance associated with interfacial contact within sulfide SE pellets. Nyquist plots of these samples are shown in FIG. 6. At 0.5 MPa, 0 wt. % PIB-LPSCl retained 64±19% of its ionic conductivity in comparison to its value at 30 MPa. 1 wt. % PIB-LPSCl, 2 wt. % PIB-LPSCl, and 5 wt. % PIB-LPSCl retained 49±1%, 44±2%, and 31±2%, respectively. As shown, interfacial resistance contribution to overall resistance increased as pressure decreased, and as binder content increased.

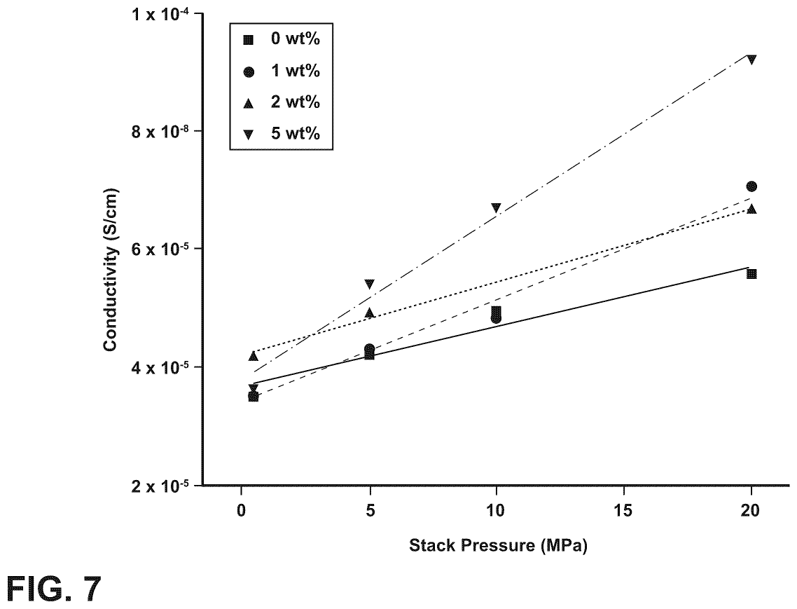

To probe the pressure dependence of conductivity in more detail, a range of pressures was studied. Conductivity as a function of stack pressure is shown in FIG. 7. Interestingly, the ionic conductivity of 5 wt. % PIB-LPSCl showed a stronger dependence on stack pressure than the samples containing less binder. Such a phenomenon may be explained as follows. The non-polar PIB binder tends to distribute at the polar LPSCl grain boundaries due to the mutual exclusion between the two objects. As the PIB-LPSCl pellet was compressed, sulfide SE particles formed intimate contacts with one another to make Li⁺ percolation pathways. Consequently, PIB chains located between particles were deformed from their equilibrium conformations to accommodate the SE particles. As the compressive force was relieved, intramolecular repulsions drove the SE particles apart to allow for the deformed chains to minimize their free energy (i.e., maximize conformational entropy). This sulfide SE particle separation resulted in a loss of interparticle contact. Thus, ion conduction pathways were lost, and conductivity decreased to a greater extent than in samples with lower PIB content.

The results of the temperature-dependent ionic conductivity tests corroborate these findings. The activation energy of each sample was found by fitting experimental data to the Vogel-Fulcher-Tammann (VFT) equation. The VFT equation is given in the following equation, where σ₀ is a prefactor, T is temperature, T₀ is the Vogel temperature, and B_{R} is the quantity Eₐ/R. Eₐ is the activation energy for ion conduction in the material, and R is the gas constant.

$$σ ( T ) = {σ}_{0} {e}^{( \frac{- {B}_{R}}{T - {T}_{0}} )}$$

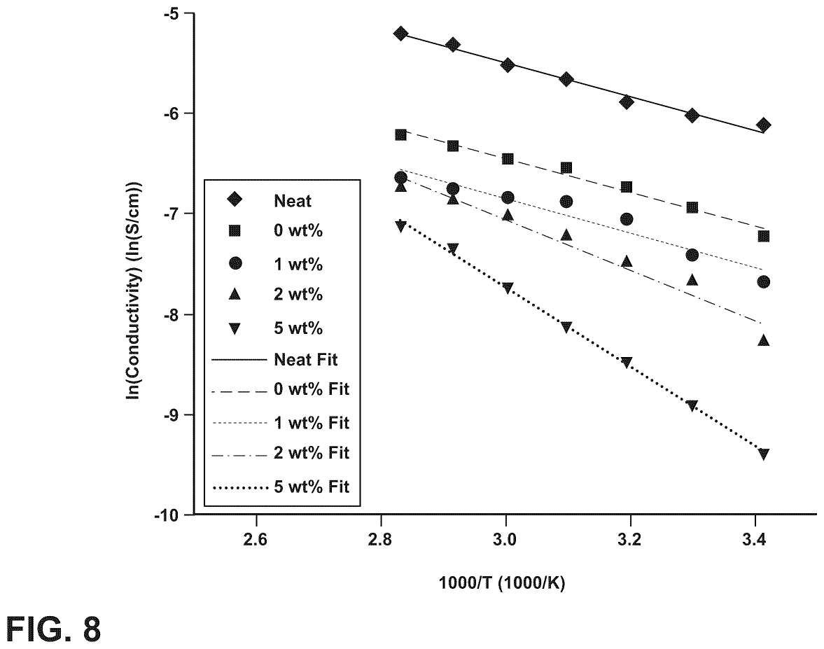

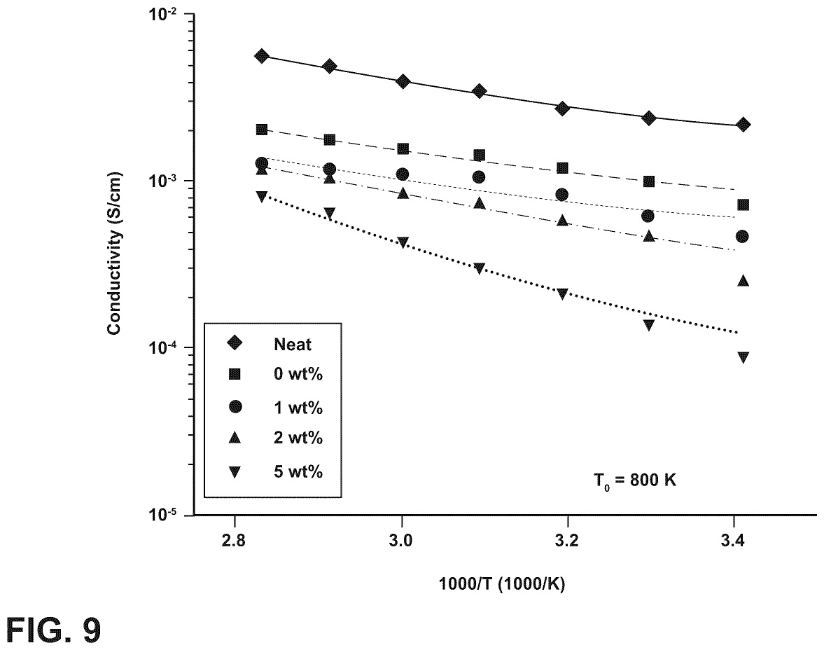

For polymer electrolytes, T₀ represents the ideal glass transition temperature, being the temperature at which configurational entropy is zero. For inorganic SEs, T₀ currently bears no physical meaning. T₀ was fixed at a value of 800 K, such that the Eₐ found for neat LPSCl was near 0.34 eV, a value previously found by Arrhenius-type fitting methods. Arrhenius fits of collected conductivity data are shown in FIG. 8, and corresponding fit parameters are given in Table 1 below. The raw data is plotted with the fit results in FIG. 9. The fit parameters, extracted activation energies, and R₂ values are given in Table 2 below.

TABLE 1
Raw data and Arrhenius fits of
temperature-dependent ionic conductivity

| PIB Content (wt. %) | Eₐ (eV) | R² |
|---|---|---|
| Neat LPSCI | 0.15 ± 0.02 | 0.982 |
| 0 | 0.15 ± 0.02 | 0.976 |
| 1 | 0.15 ± 0.04 | 0.933 |
| 2 | 0.22 ± 0.05 | 0.955 |
| 5 | 0.34 ± 0.01 | 0.999 |

TABLE 2
Results of fitting conductivity data*

| PIB | | | | | | |
|---|---|---|---|---|---|---|
| Content | | B_{R} | T₀ | | Eₐ | |
| (wt. %) | σ₀ (S/cm) | (K) | (K) | Eₐ (eV) | (kJ/mol) | R² |
| Neat | 1.47 × 10⁻⁶ | 3690 | 800 | 0.32 ± 0.03 | 31 ± 3 | 0.991 |
| LPSCI | | | | | | |
| 0 | 1.52 × 10⁻⁶ | 3220 | 800 | 0.28 ± 0.07 | 27 ± 7 | 0.956 |
| 1 | 1.26 × 10⁻⁶ | 3120 | 800 | 0.27 ± 0.10 | 26 ± 10 | 0.895 |
| 2 | 6.28 × 10⁻⁸ | 4420 | 800 | 0.38 ± 0.08 | 37 ± 8 | 0.950 |
| 5 | 5.99 × 10⁻¹¹ | 7360 | 800 | 0.64 ± 0.10 | 61 ± 10 | 0.984 |

*σ₀ is a pre-factor, T is temperature, T₀ is the Vogel temperature, B_{R} is the quantity Eₐ/R, Eₐ is the activation energy of the material, and R² is a goodness-of-fit statistic

In addition to the samples containing toluene-treated LPSCl (0-5 wt. % PIB-LPSCl), untreated LPSCl (neat LPSCl) was also tested as a control. According to the fit values, Eₐ of 0, 1, and 2 wt. % PIB-LPSCl was not significantly different than that of the neat LPSCl. However, Eₐ of 5 wt. % PIB-LPSCl was significantly greater than the other samples.

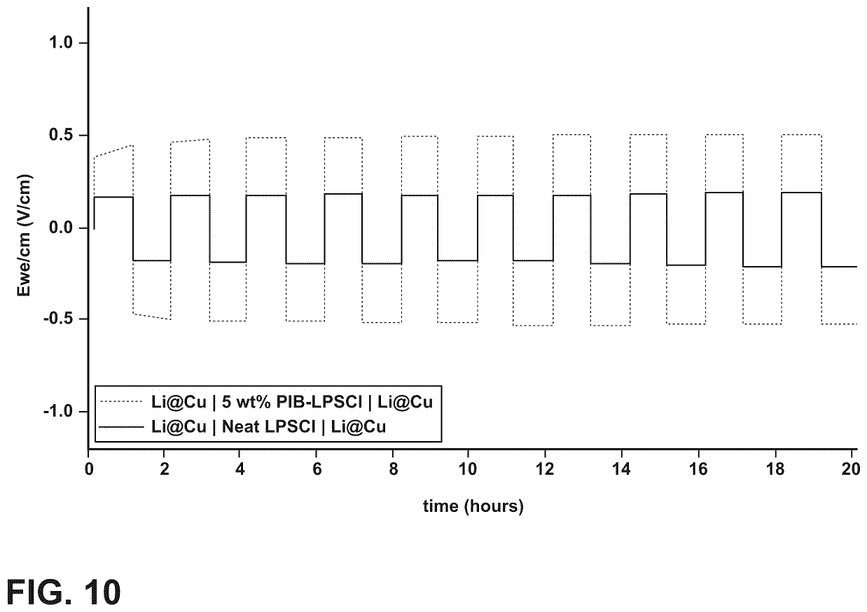

Li stripping/plating tests were conducted with the Li@Cu symmetric cells in PEEK holders under argon atmosphere at room temperature using two-hour charge/discharge cycles. The samples consisted of a neat LPSCl control cell and two stacked layers of 5 wt. % PIB-LPSCl thin sheet cell. The first ten cycles performed at 40 μA/cm² are shown in FIG. 10, where the potential (Ewe) has been normalized by the pellet thickness (1.2 mm and 0.25 mm for the neat LPSCl and 5 wt. % PIB-LPSCl, respectively). While both samples appear to reach a stable polarization by the third cycle, the 5 wt. % PIB-LPSCl thin sheets exhibited a lower signal to noise ratio at constant current. The greater magnitude of the thin sheet cell's overpotential may be due to greater electrolyte resistance within the composite.

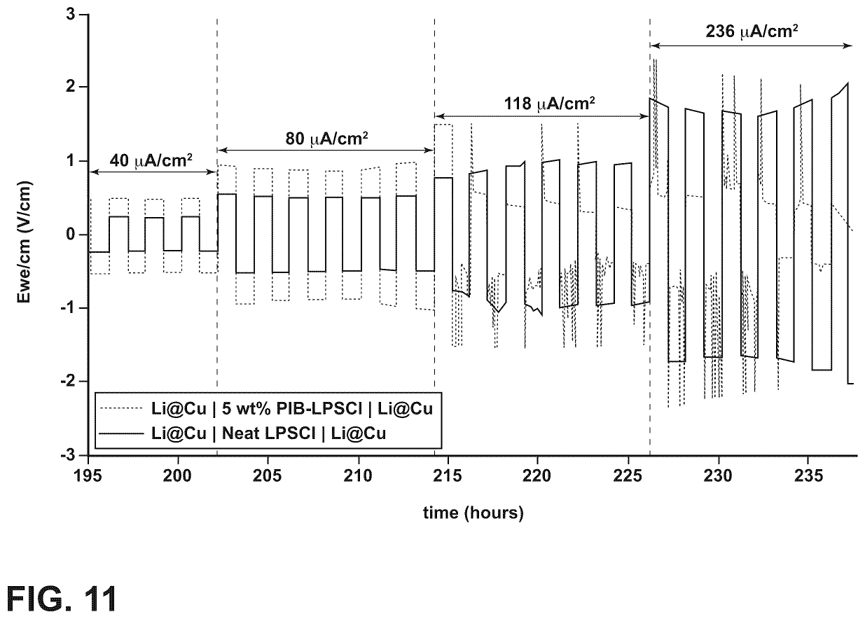

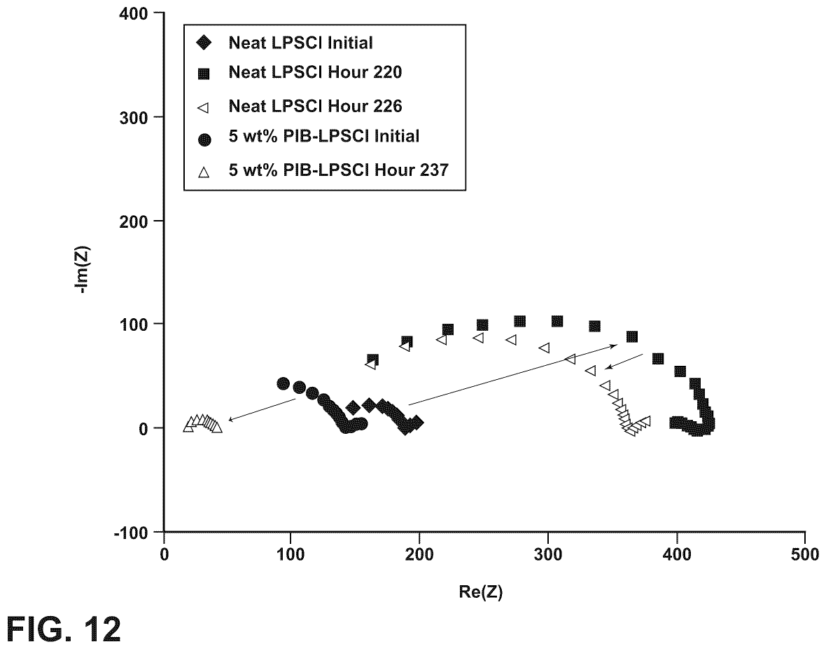

After the cells underwent 100 cycles at 40 μA/cm², a critical current density test was conducted. The results of this test are shown in FIG. 11. When the current density was increased to 80 μA/cm², the PIB-LPSCl cell began to show some instability. Upon increasing the current density to 118 μA/cm², the PIB-LPSCl cell shorted in the first cycle. At the same time, the neat LPSCl sample began to show increased polarization. During the following cycle at 118 μA/cm², the neat LPSCl sample soft shorted. Increased polarization preceding unstable polarization is known to be indicative of a contact-loss-driven short. The Nyquist plots before and after cell failure are given in FIG. 12.

The present free-standing, sheet-type solid electrolytes fabricated using slurry-based tape-casting methods revealed that even small quantities (˜2 wt. %) of a non-polar binder can yield robust sheet-type separators. A correlation was found between binder mass loading and both bulk and surface porosity. Without being bound by theory, it is believed that weak interactions of the non-polar binder with the sulfide solid electrolyte (SE) particles result in discrete pockets between sulfide SE particles, thus inhibiting the formation of long-lasting ion percolation pathways during fabrication. These pockets include void space and ionically insulating PIB. The first piece of evidence for this was shown by the greater dependence of conductivity on stack pressure for 5 wt. % PIB-LPSCl in comparison with the samples with lower binder mass loadings. The 5 wt. % PIB-LPSCl retained only about 40% of its conductivity at 0.5 MPa, as compared to that at 20 MPa. In contrast, the conductivity of 0 wt. % PIB-LPSCl showed the weakest dependence on stack pressure and retained over 65% of its conductivity from 20 MPa to 0.5 MPa. The second piece of evidence was the significantly greater activation energy of 5 wt. % PIB-LPSCl over the other samples. Presence of an insulating phase between superionic particles, whether that phase is binder or void space, led to increased activation energy. Surprisingly, these effects only became significant at binder loadings of 5 wt. %.

Additionally, the correlation between porosity and binder mass loading may have implications for stability against Li dendrite growth, as demonstrated with Li symmetric cell cycling. In the case of the 5 wt. % PIB-LPSCl cell, surface inhomogeneity results in a distribution of current densities and Li⁺ diffusion coefficients at the Li metal interface. Internal porosity has been shown to lower critical current density, and dendrite penetration can be induced by such internal defects. In terms of critical current density, the 5 wt. % PIB-LPSCl thin sheet cell showed signs of instability at nearly the same time and current density as the neat LPSCl control. This was unexpected considering the different porosity in the two samples. However, as shown in FIG. 12, they failed by different mechanisms (dendrite penetration for the 5 wt. % PIB-LPSCl and contact loss for neat LPSCl). Particularly, after shorting the resistance of the 5 wt. % PIB-LPSCl cell decreased, indicating a short via Li dendrite penetration, while in contrast the resistance of the neat LPSCl cell increased, indicating a short via contact loss. The combination of increased surface defects seeding dendrite growth and reduced dendrite propagation distance (which corresponds to film thickness) were ultimately the limiting factors for the critical current density of the thin sheet.

In summary, free-standing, sheet-type electrolytes were fabricated with as little as 1 wt. % binder. Consistent film quality was obtained with 2 wt. % binder. Electrolytes with 5 wt. % binder exhibited the greatest mechanical robustness. Ionic conductivity was found to be dependent on stack pressure and temperature. This is postulated to be due to the binder forming insulating pockets between sulfide SE particles, thus inhibiting the formation of long-lasting ion percolation pathways during fabrication. The inclusion of the binder at 5 wt. % loading allowed for fabrication of an order of magnitude thinner separator.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

What is claimed is:

1. A method of manufacturing a free-standing, sheet-type solid-state electrolyte, the method comprising:
mixing a sulfide ion conductor-containing material and a binder in a solvent to obtain a slurry composition, wherein the binder is a generally non-polar or low-polar binder;
disposing the slurry composition onto a planar substrate;
spreading the slurry composition on the substrate with one of a drawdown bar or a slot die to obtain a film;
calendering the film to densify the film; and
drying the film under vacuum.

2. The method of claim 1, further comprising the step of cold-pressing the film after calendering.

3. The method of claim 1, wherein the substrate is a silicone-coated mylar.

4. The method of claim 1, wherein the substrate is an electrode material.

5. The method of claim 1, wherein the binder is an elastomer.

6. The method of claim 5, wherein the binder is one selected from a group consisting of: polyisobutylene (PIB), styrene butadiene rubber (SBR), nitrile butadiene rubber (NBR), hydrogenated nitrile butadiene rubber (HNBR), ethylene-propylene-diene monomer (EPDM), and styrene-butadiene-styrene (SBS).

7. The method of claim 6, wherein the binder is polyisobutylene.

8. The method of claim 1, wherein the binder is present in the slurry composition in an amount of up to 10 wt. %.

9. The method of claim 8, wherein the binder is present in the slurry composition in an amount of between 1 and 5 wt. %.

10. The method of claim 1, wherein the sulfide ion conductor-containing material is a lithium argyrodite having the chemical formula Li₆PS₅X wherein X is one of Cl, Br, or I.

11. The method of claim 10, wherein the sulfide ion conductor-containing material is Li₆PS₅Cl (LPSCl).

12. The method of claim 1, wherein the sulfide ion conductor-containing material is one of Li₁₀GeP₂S₁₂ (LGPS) or Li₁₀SnP₂S₁₂ (LSPS).

13. The method of claim 1, wherein the solvent is one of toluene or xylene.

14. The method of claim 1, wherein the film has a thickness of between 10 and 200 μm.

15. A free-standing, sheet-type solid-state electrolyte manufactured by the method of claim 1.

16. The free-standing, sheet-type solid-state electrolyte of claim 15, comprising sulfide particles bound by the binder, wherein the binder is a polymer binder.

17. The free-standing, sheet-type solid-state electrolyte of claim 15, the film having a thickness of between 10 and 200 μm.
